(19) United States
(12) Patent Application Publication
(10) Pub. No.: US 2013/0179867 A1
(43) Pub. Date: Jul. 11, 2013

(54) Program Code Analysis System

(71) Applicants: Annemarie R. Fitterer, Austin, TX (US); Ramakrishna J. Gorthi, Pune (IN); Chandrajit G. Joshi, Pune (IN); Romil J. Shah, Pune (IN)

(72) Inventors: Annemarie R. Fitterer, Austin, TX (US); Ramakrishna J. Gorthi, Pune (IN); Chandrajit G. Joshi, Pune (IN); Romil J. Shah, Pune (IN)

(73) Assignee: INTERNATIONAL BUSINESS MACHINES CORPORATION, Armonk, NY (US)

(21) Appl. No.: 13/348,419

(22) Filed: Jan. 11, 2012

(51) Int. Cl. G06F 9/44

(52) U.S. Cl. 717/130

(57) ABSTRACT

A method, apparatus, and computer program product for analyzing program code. A set of differences is identified between a first program code and a second program code. A new program code is created having instrumented program code for the set of differences. The set of differences is analyzed using the instrumented program code in the new program code.

### BACKGROUND

1. Field

The disclosure relates generally to an improved data processing system and, in particular, to a method and apparatus for analyzing program code. Still more particularly, the present disclosure relates to a method and apparatus for analyzing memory use by program code.

2. Description of the Related Art

In developing software, a number of different steps are performed. Software development activities include identifying requirements for the software product. After the requirements are identified, software engineers write program code for the software project. Testing occurs during the coding process. This testing may identify defects in the software as soon as possible. During the implementation in software development, features may be added, features may be modified, defects may be fixed, and other changes may be made to the program code during the software project.

After the software product has been completed, the software may be deployed for use. After the software product has been deployed, maintenance may be performed to add features, fix problems, or take into account new requirements. The maintenance also often results in different versions of the program code generated for the software. For example, a newer version of program code for a software product may have changes from an older version of the program code. These changes may include additions of code, deletions of code, and modifications to existing code.

In performing these changes, analysis of memory use while the program is running is often performed as part of the software testing. This analysis of the program code may be referred to as dynamic memory analysis. The analysis of memory use during running of the program code for the software product is performed to determine whether changes to the code cause undesired performance in the memory of a data processing system. The analysis of the memory use may include identifying a memory leak, uninitialized memory reads, array bounds reads, array bounds writes, free memory reads, and other events that may occur in the memory during running of the program code.

The currently used tools typically perform memory analysis of the entire program by inserting instrumentation points throughout the program code. Since the analysis is performed for the entire program, these tools typically generate large reports. The size of the reports may result in requiring more time than desired to perform the memory analysis. Developers making the code changes are typically not interested in the analysis of the entire program but only for the code changes that have been made, such as the delta code in the program.

### SUMMARY

The different illustrative embodiments provide a method, apparatus, and computer program product for analyzing program code. A set of differences is identified between a first program code and a second program code. A new program code is created having instrumented program code for the set of differences. The set of differences are analyzed using the instrumented program code in the new program code.

### BRIEF DESCRIPTION OF THE SEVERAL VIEWS OF THE DRAWINGS

FIG. 1 is an illustration of a program code analysis environment in accordance with an illustrative embodiment;

FIG. 2 is an illustration of a block diagram of a comparison of program code in accordance with an illustrative embodiment;

FIG. 3 is an illustration of a flowchart of a process for analyzing program code in accordance with an illustrative embodiment; and

FIG. 4 is an illustration of a flowchart of a process for identifying a set of differences between the first program code and the second program code in accordance with an illustrative embodiment.

### DETAILED DESCRIPTION

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.), or an embodiment combining software and hardware aspects that may all generally be referred to herein as a “circuit”, “module”, or “system”. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction processing system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction processing system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present disclosure may be written in any combination of one or more programming languages, including an object-oriented programming language, such as Java, Smalltalk, C++, or the like and conventional procedural programming languages, such as the “C” programming language or similar programming languages. The program code may run entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowcharts and/or block diagrams of methods, apparatus (systems), and computer program products according to embodiments of the disclosure. It will be understood that each block of the flowcharts and/or block diagrams, and combinations of blocks in the flowcharts and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer-implemented process such that the instructions which run on the computer or other programmable apparatus provide processes for implementing the functions/acts specified in the flowchart and/or block diagram block or blocks.

The illustrative embodiments recognize and take into account a number of different considerations. For example, the illustrative embodiments recognize and take into account that with currently used tools, all of the program code for a program is analyzed. As a result, the analysis of the program code generates reports that are larger than desired. Further, these reports typically are examined by a human user to identify false alarms and actual issues. This process may be more time-consuming than desired. Further, the human user may miss issues during the analysis of these large reports.

The different illustrative embodiments also recognize and take into account that the problem is further complicated when the memory analysis is performed for different versions of the same program. For example, an analysis of memory use may be performed to determine whether a memory leak is caused by a particular version of the program code. The different versions of program code for a program typically involve features, functions, and fixes that may be present throughout the program code. As a result, the analysis is currently performed separately on the two versions of the program code. The reports for the analysis are then compared to determine which version may have caused the memory leak.

Thus, the different illustrative embodiments provide a method and apparatus for analyzing program code. The illustrative embodiments provide a method, apparatus, and computer program product for analyzing program code. A set of differences is identified between a first program code and a second program code. A new program code is created having instrumented program code for the set of differences. The set of differences is analyzed using the instrumented program code introduced in the new program code.

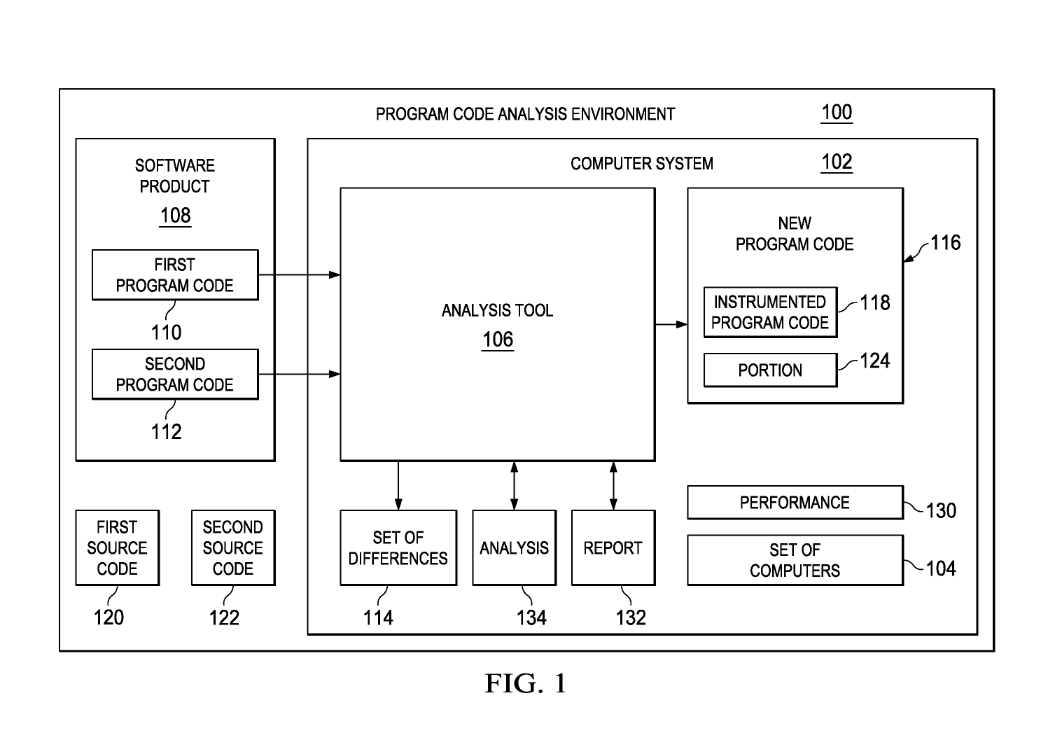

With reference now to the figures and, in particular, with reference to FIG. 1, an illustration of a program code analysis environment is depicted in accordance with an illustrative embodiment. In this illustrative example, computer system 102 is present in program code analysis environment 100. Computer system 102 comprises set of computers 104. A “set,” as used herein with reference to items, means one or more items. For example, “set of computers 104” is one or more computers. When more than one computer is present in computer system 102, those computers may be in communication with each other. This communication may be facilitated through a medium, such as a network. This network may be, for example, without limitation, a local area network, a wide area network, an intranet, the Internet, and some other suitable type of network.

In these illustrative examples, analysis tool 106 is located on computer system 102. Analysis tool 106 may comprise hardware, software, or a combination of the two. Analysis tool 106 may be used to analyze software product 108.

Software product 108 may be, for example, without limitation, a program, an application, a plug-in, or some other form of program code. In these illustrative examples, analysis tool 106 may receive first program code 110 and second program code 112 for analysis. First program code 110 and second program code 112 may be different versions of software product 108. In these illustrative examples, first program code 110 and second program code 112 are executable program code.

In these illustrative examples, executable program code is a set of computer program instructions. The set of computer program instructions is run on a processor. The processor may be in a general purpose computer, special purpose computer, or other programmable data processing apparatus to implement the process for software product 108. In particular, first program code 110 and second program code 112 may be in binary code, bytecodes, scripts, or some other form of executable program code.

In these illustrative examples, analysis tool 106 compares first program code 110 and second program code 112. A comparison is made to identify set of differences 114 between first program code 110 and second program code 112. After set of differences 114 has been identified, analysis tool 106 creates new program code 116 from set of differences 114 using first program code 110, second program code 112, or both.

New program code 116 created by analysis tool 106 includes instrumented program code 118. In these illustrative examples, instrumented program code 118 is created by analysis tool 106 for analysis of set of differences 114. For example, if set of differences 114 includes a new function added to second program code 112 but not present in first program code 110, instrumented program code 118 corresponds to code added by analysis tool 106 for analysis of the new function.

In these illustrative examples, the code added by analysis tool 106 for analysis of set of differences 114 may include, for example, binary code, bytecode, script, or some other form of executable program code added to second program code 112. In these illustrative examples, analysis tool 106 may also add code to second program code 112 by modifying the source code of second program code 112. Source code is a set of instructions in a programming language. The source code may be used to create a software product, modify the software product, or a combination of the two. The source code may be stored in a computer. For example, the source code may be stored as an editable text file or any other suitable type of file. Further, the source code may be written in any programming language or script language. Some programming languages may require conversion of the source code into a set of instructions that can be run by a processor unit. The conversion may be performed using a compiler or other similar tool. Some script languages do not require conversion and may be run on a processor unit without changes.

In another example, if set of differences 114 includes a function call present in first program code 110 but removed in second program code 112, instrumented program code 118 corresponds to code added by analysis tool 106 for analysis of the removed function call.

In still another example, if set of differences 114 includes a change to code between first program code 110 and second program code 112, instrumented program code 118 corresponds to code added by analysis tool 106 for analysis of the changed code. In these illustrative examples, new program code 116 is in an executable form ready for analysis. In other words, new program code 116 may include instrumented program code 118 in a form that is ready for performing various types of analysis. In these illustrative examples, instrumented program code 118 may be created by analysis tool 106 using any known mechanisms used by existing memory analysis tools for program code analysis.

In these illustrative examples, the comparison of first program code 110 with second program code 112 may be made directly using first program code 110 and second program code 112 in the form of executable code. For example, when first program code 110 and second program code 112 are in the form of bytecodes, the executable code may be decompiled to identify source code for comparison. The identification of source code from the executable code may be formed using metadata, conversion tables, or other suitable mechanisms.

In these illustrative examples, symbol information for first program code 110 may be used to locate the associated first source code 120. The symbol information of second program code 112 may be used to locate the associated second source code 122. The combination of symbol tables of first program code 110, second program code 112, and their respective first source code 120 and second source code 122 may be used to identify set of differences 114 between first program code 110 and second program code 112 when first program code 110 and second program code 112 take the form of executable program code.

In other illustrative examples, set of differences 114 between first program code 110 and second program code 112 may be identified using existing techniques for comparison of executable binaries.

After new program code 116 has been created with instrumented program code 118, analysis tool 106 may perform analysis 134 on new program code 116 using instrumented program code 118. In other words, analysis 134 may be performed on set of differences 114 and portions 124 of base code using instrumented program code 118 and not on any other portions of new program code 116.

As depicted, analysis 134 may begin by running new program code 116. In particular, the analysis is performed on set of differences 114 using instrumented program code 118 in new program code 116. In addition, other portions of new program code 116 also may be analyzed.

Portions 124 of new program code 116 referenced by set of differences 114 may take various forms. For example, portions 124 may be program code that makes function calls, performs a function, instantiates a data object, modifies a data object, or other suitable actions. In particular, when memory analysis is performed, portions 124 of new program code 116 may be of interest when portions 124 of new program code 116 involve a new use of data objects.

For example, portions 124 of new program code 116 may include allocating memory for a data object, deallocating memory for a data object, or other suitable types of manipulations of data objects that may affect memory use. In these illustrative examples, instrumented program code 118 also may include code created by analysis tool 106 for analysis of portions 124. For example, if a function in portions 124 is referenced by a new function in set of differences 114, instrumented program code 118 may include code added by analysis tool 106 to the function in portions 124 for analysis of the function.

After new program code 116 has been instrumented, new program code 116 includes instrumented program code 118. Analysis tool 106 runs instrumented program code 118 to perform analysis 134 of instrumented program code 118. Analysis 134 may be used to identify performance 130 of set of differences 114 and portions 124 using instrumented program code 118. This performance may include performance related to memory use, execution times, processor use, and other suitable metrics that may be desired with respect to software product 108 that may be caused by set of differences 114. In one illustrative example, performance related to memory use may include memory leaks, uninitialized memory reads, array bounds reads, array bounds writes, free memory reads, and other suitable metrics.

In these illustrative examples, report 132 may indicate issues pertaining to set of differences 114. Further, report 132 also may include issues pertaining to portions 124 of new program code 116 referenced by set of differences 114.

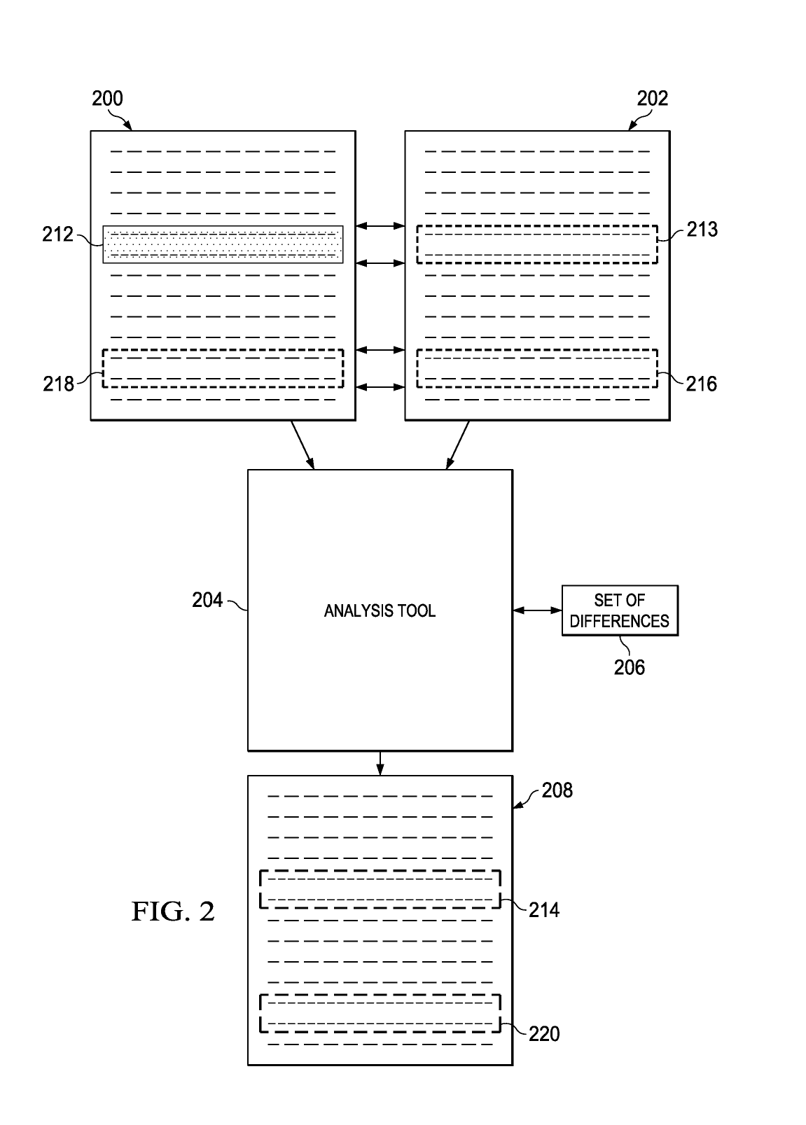

Turning now to FIG. 2, an illustration of a block diagram of a comparison of program code is depicted in accordance with an illustrative embodiment. In this illustrative example, first program code 200 and second program code 202 are executable program code. As depicted, first program code 200 is executable program code built from a base source code. Second program code 202 represents program code that contains new and changed code on top of the base code in first program code 200.

As depicted, analysis tool 204 compares first program code 200 and second program code 202 with each other and identifies set of differences 206. As a result, analysis tool 204 generates new program code 208.

In this illustrative example, new program code 208 includes set of differences 206. In these illustrative examples, new program code 208 represents new program code added to second program code 202 as compared to first program code 200. For example, section 212 in first program code 200 is an absence of lines of program code in section 213 in second program code 202. This difference between first program code 200 and second program code 202 is indicated in new program code 208 using section 214 of new program code 208. Section 214 comprises section 213 of second program code 202 and instrumented program code added for analysis of section 213.

As another example, lines of program code in section 216 of second program code 202 are added and/or modified as compared to section 218 in first program code 200. In other words, lines of program code in section 218 may be replaced with any combination of new lines of program code, modified lines of program code, and removed lines of program code. This difference between first program code 200 and second program code 202 is indicated in new program code 208 using section 220. Section 220 represents section 216 of second program code 202 with instrumentation code added in it for program analysis of section 216.

In this manner, sections in new program code 208 representing differences between first program code 200 and second program code 202 may be instrumented to analyze the differences without analyzing other portions of new program code 208. As a result, the results of the analysis may be shorter and easier to analyze. Further, the time needed to run an analysis of new program code 208 also may be reduced in contrast to instrumenting all of new program code 208.

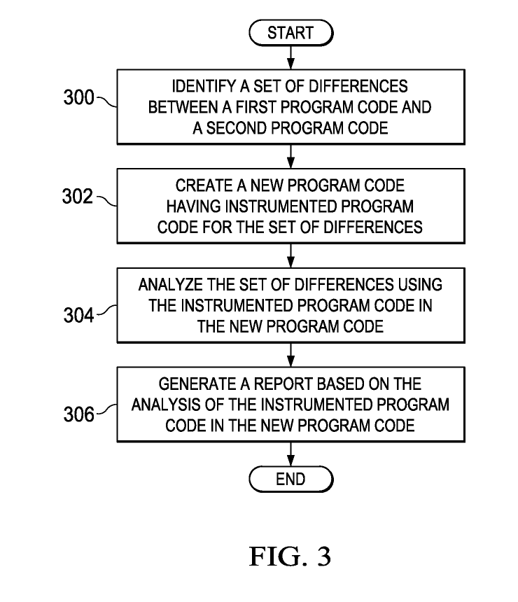

With reference now to FIG. 3, an illustration of a flowchart of a process for analyzing program code is depicted in accordance with an illustrative embodiment. The process illustrated in FIG. 3 may be implemented in program code analysis environment 100 in FIG. 1 using computer readable program code. In these illustrative examples, this process may be implemented in analysis tool 106.

The process begins by identifying a set of differences between a first program code and a second program code (step 300). Thereafter, a new program code is created having instrumented program code for the set of differences (step 302). For example, instrumented program code may be added in each portion of the new program code containing a difference between the first program code and the second program code. As another example, portions of the new program code referenced by the set of differences may also be identified. In this example, instrumented program code may be introduced in each portion of the new program code identified as being referenced by program code in the set of differences.

The process then analyzes the set of differences using the instrumented program code in the new program code (step 304). A report may be generated based on the analysis of the instrumented program code in the new program code (step 306), with the process terminating thereafter. In these illustrative examples, the report based on the analysis may be in the form of a notice sent to a user. For example, a user may be a tester of the software product and may be notified of the results of the analysis. In this example, the notification may also be based on a determination that a threshold has been exceeded regarding the analysis. A report may be sent to the tester. The report may identify a memory leak in the second program code that exceeds a pre-defined threshold for memory leaks set by the tester. In yet other illustrative examples, the report may be a user interface of a debugging program.

In these illustrative examples, the analysis of each version of the program code may be stored for later use. Further, the report may include an aggregation of the analysis performed on the instrumented program code for a plurality of versions of program code. For example, when a new version of the program code is created, the process may retrieve all prior analysis previously performed on the program code. The process may then use the retrieved analysis to report a set of changes over time for the number of versions of the program code. In these illustrative examples, the analysis and reporting may be performed by any software, hardware, or combination of software and hardware configured to analyze and report the results of instrumented program code.

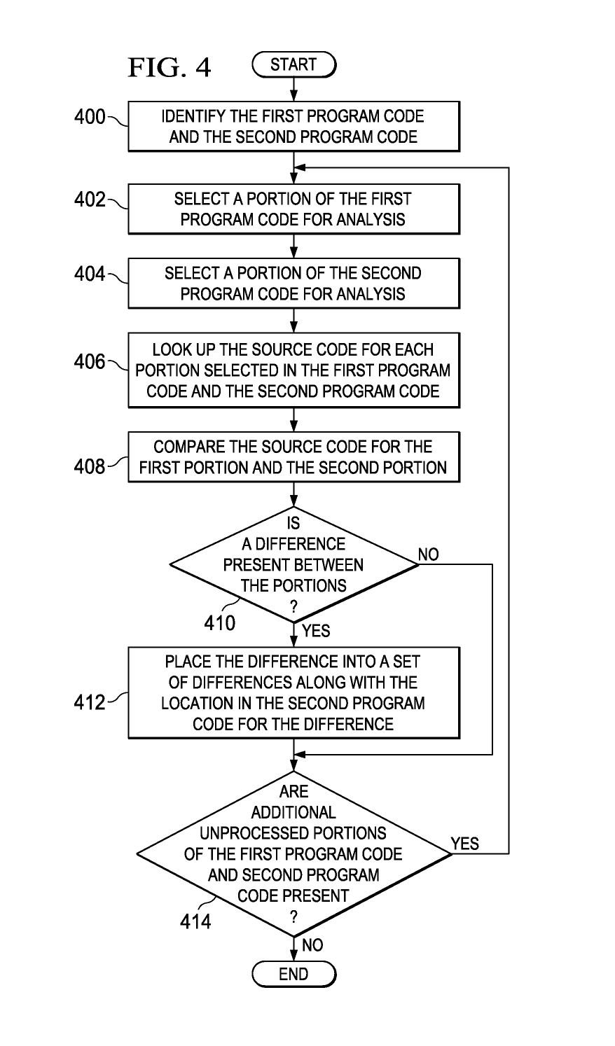

With reference now to FIG. 4, an illustration of a flowchart of a process for identifying a set of differences between the first program code and the second program code is depicted in accordance with an illustrative embodiment. The process illustrated in FIG. 4 is an example of an implementation of step 300 in FIG. 3.

The process begins by identifying the first program code and the second program code (step 400). In these illustrative examples, the first program code and second program code are executable forms of program code. The first program code is the base or code that is being compared to the second program code. The second program code contains changes from the first program code. The process selects a portion of the first program code for analysis (step 402). The process then selects a portion of the second program code for analysis (step 404).

The process looks up the source code for each portion selected in the first program code and the second program code (step 406). A comparison of the source code for the first portion and the second portion is made (step 408). A determination is made as to whether a difference is present between the portions (step 410). If a difference is present, the difference is placed into a set of differences along with the location in the second program code for the difference (step 412). In this illustrative example, the difference may be the new or modified program code. In some illustrative examples, the difference may be an identification of locations of where program code has been removed.

A determination is made as to whether additional unprocessed portions of the first program code and second program code are present (step 414). If additional unprocessed portions of program code are not present, the process terminates. Otherwise, the process returns to step 402 as described above. With reference again to step 410, if a difference is not present, the process proceeds directly to step 414 as described above.

Thus, one or more of the different illustrative embodiments provides a method, apparatus, and computer program product for analyzing program code. With an illustrative embodiment, an analysis of only portions of the program code that have changed may be performed. In these illustrative examples, this performance may be used to reduce the time needed for analyzing the performance of a software product when changes are made. For example, performance in the form of memory use may be identified. This performance may be used to make additional changes or revisions to the program code for the software product.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowcharts and block diagrams in the figures illustrate the architecture, functionality, and operation of possible implementations of systems, methods, and computer program products according to various embodiments of the present disclosure. In this regard, each block in the flowcharts or block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be processed substantially concurrently, or the blocks may sometimes be processed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts, or combinations of special purpose hardware and computer instructions.

What is claimed is:

1. A method for analyzing program code, the method comprising:
identifying a set of differences between a first program code and a second program code;
creating a new program code having instrumented program code for the set of differences; and
analyzing the set of differences using the instrumented program code in the new program code.

2. The method of claim 1, wherein identifying the set of differences between the first program code and the second program code comprises:
comparing the first program code to the second program code to identify the set of differences.

3. The method of claim 1, wherein identifying the set of differences between the first program code and the second program code comprises:
identifying a first source code for the first program code;
identifying a second source code for the second program code; and
identifying the set of differences between the first program code and the second program code from the first source code and the second source code.

4. The method of claim 1, wherein analyzing the set of differences using the instrumented program code in the new program code comprises:
running the instrumented program code to identify a performance of the instrumented program code.

5. The method of claim 4, wherein the performance is memory use by the instrumented program code.

6. The method of claim 1, wherein the instrumented program code is a first instrumented program code, and wherein creating the new program code further comprises:
identifying portions of the new program code referenced by the first instrumented program code; and
including in the new program code a second instrumented program code for the portions of the new program code referenced by the first instrumented program code.

7. The method of claim 6 further comprising:
generating a report based on an analysis of the first instrumented program code and the second instrumented program code in the new program code.

8. The method of claim 7, wherein generating the report based on the analysis of the first instrumented program code and the second instrumented program code in the new program code comprises:
indicating issues pertaining to the set of differences in the new program code and the portions of the new program code referenced by the set of differences.

9. The method of claim 1, wherein the first program code, the second program code, and the new program code are executable program code.

10. The method of claim 1, wherein creating the new program code having the instrumented program code for the set of differences comprises:
adding, by an analysis tool, the program code to the second program code, wherein the program code is configured to analyze the set of differences.

11. A computer comprising:
a bus;
a processor unit connected to the bus;
a computer readable storage device connected to the bus; and
program code for identifying a set of differences between a first program code and a second program code; creating a new program code having instrumented program code for the set of differences; and analyzing the set of differences using the instrumented program code in the new program code.

12. The computer of claim 11, wherein the program code for analyzing the set of differences using the instrumented program code in the new program code comprises running the instrumented program code to identify a performance of the instrumented program code.

13. The computer of claim 12, wherein the performance is memory use by the instrumented program code.

14. The computer of claim 11, wherein the instrumented program code is a first instrumented program code, and wherein the program code for creating the new program code further comprises program code for identifying portions of the new program code referenced by the first instrumented program code; and including in the new program code a second instrumented program code for the portions of the new program code referenced by the first instrumented program code.

15. A computer program product comprising:
a computer readable storage medium;
program code, stored on the computer readable storage medium, for identifying a set of differences between a first program code and a second program code;
program code, stored on the computer readable storage medium, for creating a new program code having instrumented program code for the set of differences; and
program code, stored on the computer readable storage medium, for analyzing the set of differences using the instrumented program code in the new program code.

16. The computer program product of claim 15, wherein the program code, stored on the computer readable storage medium, for analyzing the set of differences using the instrumented program code in the new program code comprises:
program code for running the instrumented program code to identify a performance of the instrumented program code.

17. The computer program product of claim 16, wherein the performance is memory use by the instrumented program code.

18. The computer program product of claim 15, wherein the instrumented program code is a first instrumented program code, and wherein the program code for creating the new program code further comprises program code for identifying portions of the new program code referenced by the first instrumented program code; and including in the new program code a second instrumented program code for the portions of the new program code referenced by the first instrumented program code.

19. The computer program product of claim 15, wherein the computer readable storage medium is in a data processing system, and the program code is downloaded over a network from a remote data processing system to the computer readable storage medium in the data processing system.

20. The computer program product of claim 19, wherein the computer readable storage medium is a first computer readable storage medium, wherein the first computer readable storage medium is in a server data processing system, and wherein the program code is downloaded over the network to the remote data processing system for use in a second computer readable storage medium in the remote data processing system.
